(19) United States
(12) Patent Application Publication
(10) Pub. No.: US 2026/0292721 A1
(43) Pub. Date: Sep. 24, 2026

(54) TERMINAL DEVICE, BASE STATION DEVICE, AND WIRELESS COMMUNICATION SYSTEM

(71) Applicant: 1FINITY Inc., Kawasaki-shi (JP)

(72) Inventors: Kazuo KAWABATA, Yokohama (JP); Nobukazu FUDABA, Yokohama (JP)

(73) Assignee: 1FINITY Inc., Kawasaki-shi (JP)

(21) Appl. No.: 19/681,421

(22) Filed: May 19, 2026

Related U.S. Application Data
(63) Continuation of application No. PCT/JP2023/041853, filed on Nov. 21, 2023.

(51) Int. Cl. H04W 56/00

(52) U.S. Cl. CPC H04W 56/001

(57) ABSTRACT

A terminal device includes: a memory, and processor circuitry coupled to the memory and the processor circuitry configured to: receive a second signal including information on a predetermined timing at which a different terminal device transmits a first signal to a base station device, from the base station device; and provide a first state in which first power is receivable, at the predetermined timing, in response to the second signal.

### CROSS-REFERENCE TO RELATED APPLICATION

This application is a continuation application of International Application Number PCT/JP2023/041853 filed on Nov. 21, 2023 and designated the U.S., the entire contents of which are incorporated herein by reference.

### FIELD

The present disclosure relates to a terminal device, a base station device, and a wireless communication system.

### BACKGROUND

A terminal device such as, for example, a smartphone or an Internet of Things (IoT) device (hereinafter also simply referred to as a terminal device) has a built-in battery, and there is a need to charge or replace the battery as appropriate. For this reason, in recent years, there has been developed, for example, a wireless communication system that charges a terminal device with power of a signal (hereinafter also simply referred to as a transmission signal) transmitted from a base station device (see, for example, JP 2019-508999 A, JP2020-167822 A, and JP2020-080635 A).

In this regard, in the wireless communication system as described above, for example, in a case where the terminal device is located far from the base station device, propagation loss of power of the transmission signal from the base station device increases, and thus, feeding of power in a wireless manner (hereinafter referred to as wireless power feeding) from the base station device to the terminal device is not efficiently performed.

In view of this, in the wireless communication system, for example, a plurality of relay devices that relay the transmission signal from the base station device are arranged, which prevents occurrence of propagation loss of power, and thus, reduction in efficiency of wireless power feeding can be suppressed. However, in this case, for example, there is a need to perform maintenance of each relay device, resulting in an increase in work load associated with management of the wireless communication system.

Further, in the wireless communication system, for example, beamforming of the transmission signal from the base station device is performed, which enables suppression of dispersion of beams in the transmission signal. However, in this case, for example, propagation loss of power between the base station device and the terminal device is not eliminated, and thus, reduction in efficiency of wireless power feeding is not sufficiently suppressed.

### SUMMARY

According to an aspect of the embodiments, a terminal device includes: a memory, and a processor coupled to the memory and the processor configured to: receive a second signal including information on a predetermined timing at which a different terminal device transmits a first signal to a base station device, from the base station device; and provide a first state in which first power is receivable, at the predetermined timing, in response to the second signal.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a view for describing a configuration of a wireless communication system 10.

FIG. 2 is a view for describing a hardware configuration of a base station device 1.

FIG. 3 is a view for describing a hardware configuration of a terminal device 2.

FIG. 4 is a view for describing a hardware configuration of the terminal device 2.

FIG. 5 is a view for describing functions of the base station device 1 in first embodiment.

FIG. 6 is a view for describing information stored in an information storage area 130 in the first embodiment.

FIG. 7 is a view for describing functions of the terminal device 2 in the first embodiment.

FIG. 8 is a view for describing information stored in an information storage area 230 in the first embodiment.

FIG. 9 is a sequence chart of a power-feeding control process in the first embodiment.

FIG. 10 is a flowchart for describing details of the power-feeding control process in the first embodiment.

FIG. 11 is a flowchart for describing the details of the power-feeding control process in the first embodiment.

FIG. 12 is a flowchart for describing the details of the power-feeding control process in the first embodiment.

FIG. 13 is a flowchart for describing the details of the power-feeding control process in the first embodiment.

FIG. 14 is a flowchart for describing the details of the power-feeding control process in the first embodiment.

FIG. 15 is a flowchart for describing the details of the power-feeding control process in the first embodiment.

FIG. 16 is a flowchart for describing the details of the power-feeding control process in the first embodiment.

FIG. 17 is a view for describing a specific example of individual terminal information 231.

FIG. 18 is a view for describing a specific example of power-feeding request information 232.

FIG. 19 is a view for describing a specific example of neighboring terminal information 131.

FIG. 20 is a view for describing a specific example of power-feeding target information 132.

FIG. 21 is a view for describing a specific example of transmission timing information 133.

FIG. 22 is a view for describing a specific example of the transmission timing information 133.

FIG. 23 is a view for describing a specific example of a timing reception process in the power-feeding control process in the first embodiment.

FIG. 24 is a view for describing a specific example of the timing reception process in the power-feeding control process in the first embodiment.

FIG. 25 is a view for describing a specific example of the transmission timing information 133.

FIG. 26 is a view for describing a specific example of the timing reception process in the power-feeding control process in the first embodiment.

FIG. 27 is a view for describing a specific example of the transmission timing information 133.

FIG. 28 is a view for describing a specific example of the timing reception process in the power-feeding control process in the first embodiment.

### DESCRIPTION OF EMBODIMENTS

An embodiment of the present disclosure will be described below with reference to the drawings. However, the description is not to be construed in a limiting sense and does not limit the claimed subject matter. In addition, various changes, substitutions, and modifications can be made without departing from the gist and scope of the present disclosure. In addition, different embodiments can be appropriately combined.

### Configuration of Wireless Communication System in First Embodiment

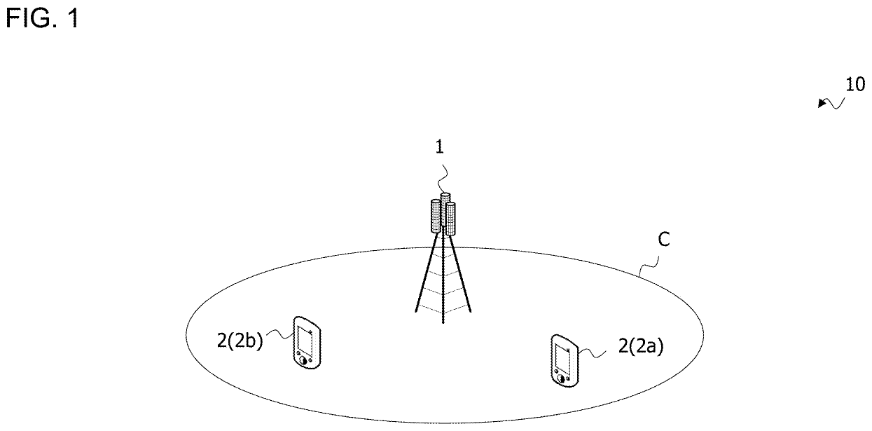

First, a configuration of a wireless communication system 10 will be described. FIG. 1 is a view for describing a configuration of the wireless communication system 10.

As illustrated in FIG. 1, the wireless communication system 10, for example, includes a base station device 1, a terminal device 2a, and a terminal device 2b. Hereinafter, the terminal device 2a and the terminal device 2b are also collectively and simply referred to as a terminal device 2.

As illustrated in FIG. 1, the base station device 1, for example, forms a cell C. Then, each of the terminal device 2a and the terminal device 2b, for example, is located in the cell C and is wirelessly connected to the base station device 1.

Note that the wireless communication system 10 may be, for example, a wireless communication system compliant with the communication standards of 5th generation mobile communication system (5G). Further, the terminal device 2 may be, for example, a communication device such as a smartphone owned by an individual, or an IoT device installed outdoors or the like. Moreover, in the following description, it is assumed that two terminal devices 2 (the terminal device 2a and the terminal device 2b) are located in the cell C, but, for example, another number of terminal devices 2 may be located in the cell C. Furthermore, in the following description, it is assumed that the wireless communication system 10 includes one base station device 1, but the wireless communication system 10 may include, for example, another number of base station devices 1.

Then, the terminal device 2, for example, has a built-in battery, and there is a need to perform charging and the like as appropriate. Thus, the terminal device 2, for example, is subjected to charging using power of a transmission signal from the base station device 1.

In this respect, in the wireless communication system 10, for example, in a case where the terminal device 2 is located far from the base station device 1, propagation loss of power of the transmission signal from the base station device 1 increases, and thus, wireless power feeding from the base station device 1 to the terminal device 2 is not efficiently performed.

For this reason, in some cases, in the wireless communication system 10, for example, a plurality of relay devices (not illustrated) that relay the transmission signal from the base station device 1 are arranged, which prevents occurrence of propagation loss of power, and thus, reduction in efficiency of wireless power feeding is suppressed. However, in this case, for example, there is a need to perform maintenance of each relay device, resulting in an increase in work load associated with management of the wireless communication system 10.

Further, in some cases, in the wireless communication system 10, for example, beamforming of the transmission signal from the base station device 1 is performed, to suppress dispersion of beams in the transmission signal. However, in this case, for example, propagation loss of power between the base station device 1 and the terminal device 2 is not eliminated, and thus, reduction in efficiency of wireless power feeding is not sufficiently suppressed.

Meanwhile, the terminal device 2 according to the present embodiment, for example, receives, from the base station device 1, a signal (hereinafter also referred to as a second signal) including information on a timing (hereinafter also referred to as a transmission timing or a predetermined timing) at which a different terminal device 2 (hereinafter also simply referred to as a neighboring terminal device 2) located in the vicinity of the terminal device 2 transmits a signal (hereinafter also referred to as a first signal) to the base station device 1. Then, the terminal device 2, for example, places the terminal device 2 at the transmission timing into a state (hereinafter also referred to as a first state) in which the terminal device 2 can receive power fed wirelessly (hereinafter also referred to as first power), in response to reception of the second signal transmitted from the base station device 1.

That is, in time division duplex (TDD), for example, the base station device 1 and each terminal device 2 in the same cell C transmit signals in the same frequency band. Thus, each terminal device 2, for example, can use the neighboring terminal device 2 located in the same cell C as a power generation source in wireless power feeding in the same manner as the terminal device 2 uses the base station device 1 as a power generation source in wireless power feeding. Note that, for example, in a case where a receivable frequency band is wide, the terminal device 2 may separate a frequency used for power feeding and a frequency used for signal reception. Separating a frequency used for power feeding and a frequency used for signal reception as described above enables use in a method other than time division duplex.

Thus, the terminal device 2 in the present embodiment, for example, receives power of a signal transmitted from the neighboring terminal device 2 to the base station device 1, instead of power of a signal transmitted from the base station device 1, or together with power of a signal transmitted from the base station device 1. Then, the terminal device 2, for example, is charged by using the received power. Further, the terminal device 2, for example, performs communication with the base station device 1 and the like by using the received power.

Specifically, in an example illustrated in FIG. 1, the terminal device 2a, for example, receives power of a signal transmitted to the base station device 1 from the terminal device 2b located in the same cell C as the terminal device 2a, and is charged and performs communication by using the received power.

Thus, the terminal device 2 in the present embodiment, for example, can receive power by wireless power feeding regardless of a distance to the base station device 1, in other words, without being affected by propagation loss of power of a transmission signal from the base station device 1. Therefore, the wireless communication system 10 in the present embodiment, for example, can efficiently perform wireless power feeding to the terminal device 2 without installation of a relay device between the base station device 1 and the terminal device 2, or the like.

### Hardware Configuration of Communication System

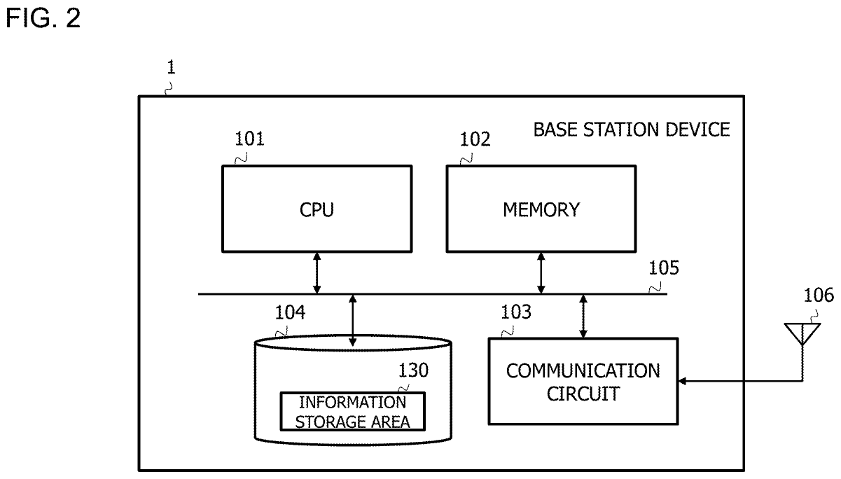

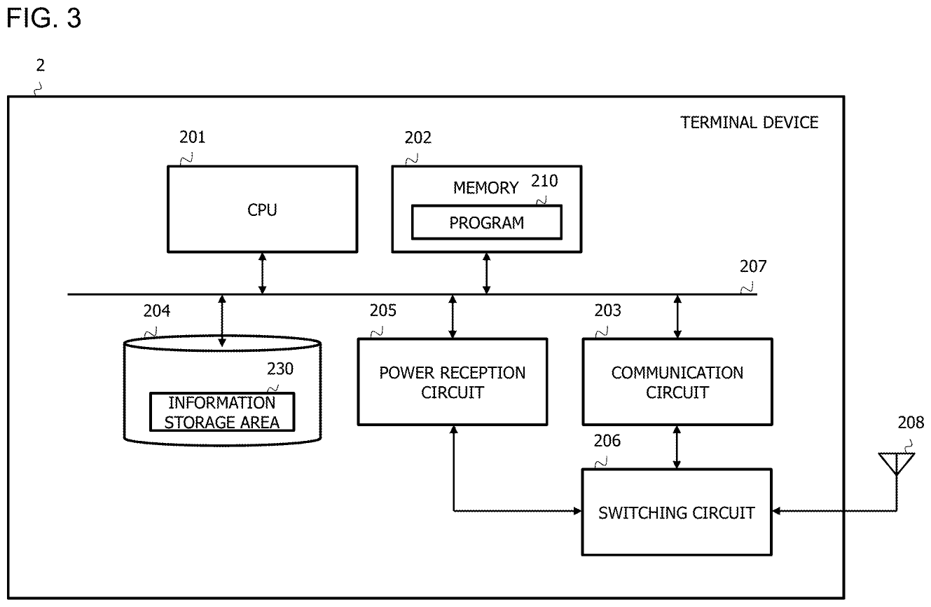

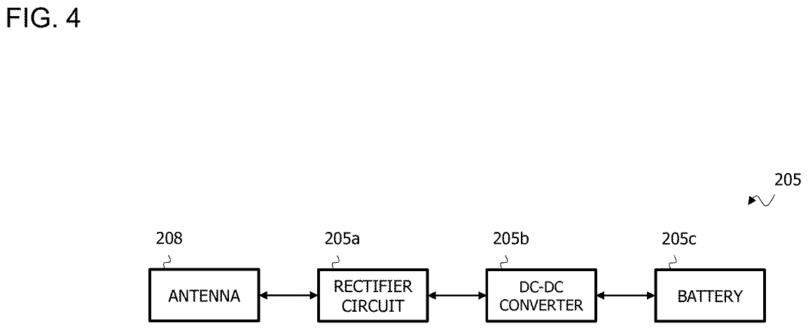

Next, a hardware configuration of the wireless communication system 10 is described. FIG. 2 is a view for describing a hardware configuration of the base station device 1. Further, FIG. 3 and FIG. 4 are views for describing a hardware configuration of the terminal device 2.

First, a hardware configuration of the base station device 1 is described. As illustrated in FIG. 2, the base station device 1, for example, includes a central processing unit (CPU) 101 that is a processor, a memory 102, a communication circuit 103, and a storage device 104. The respective units are connected to one another via a bus 105.

The storage device 104, for example, includes a program storage area (not illustrated) in which a program (not illustrated) for performing a process (hereinafter also referred to as a power-feeding control process) of controlling wireless power feeding to the terminal device 2 is stored. Further, the storage device 104 includes, for example, a storage unit 130 (hereinafter also referred to as an information storage area 130) in which information used for the power-feeding control process is stored. Note that the storage device 104 may be, for example, a hard disk drive (HDD) or a solid state drive (SSD).

The CPU 101, for example, executes the program loaded from the storage device 104 into the memory 102 and performs the power-feeding control process.

Meanwhile, the communication circuit 103 includes, for example, a circuit that is wirelessly connected to each terminal device 2 via an antenna 106 and performs communication.

Next, a hardware configuration of the terminal device 2 is described. As illustrated in FIG. 3, the terminal device 2 includes, for example, a CPU 201 that is a processor, a memory 202, a communication circuit 203, a storage device 204, and a power reception circuit 205 (hereinafter also simply referred to as a power reception unit). The respective units are connected to one another via a bus 207. Further, the terminal device 2 includes, for example, a switching circuit 206.

The storage device 204, for example, includes a program storage area (not illustrated) in which a program 210 for performing the power-feeding control process is stored. Further, the storage device 204, for example, includes a storage unit 230 (hereinafter also referred to as an information storage area 230) in which information used for the power-feeding control process is stored. Note that the storage device 204 may be, for example, an HDD or an SSD.

The CPU 201, for example, executes the program 210 loaded from the storage device 204 into the memory 202 and performs the power-feeding control process.

The communication circuit 203, for example, includes a circuit that is wirelessly connected to the base station device 1 and the neighboring terminal device 2 via an antenna 208 and performs communication.

The power reception circuit 205, for example, includes a circuit that receives power of a signal transmitted from the base station device 1 or the neighboring terminal device 2, via the antenna 208, and is charged.

Specifically, as illustrated in FIG. 4, the power reception circuit 205, for example, includes a rectifier circuit 205a that converts power of a signal received via the antenna 208 from AC power to DC power, a DC-DC converter 205b that converts a voltage of the power rectified in the rectifier circuit 205a, and a battery 205c that is charged with the power whose voltage has been converted in the DC-DC converter 205b.

Meanwhile, the switching circuit 206, for example, switches a destination of transmission of a signal received via the antenna 208 between the communication circuit 203 and the power reception circuit 205.

### Functions of Communication System in First Embodiment

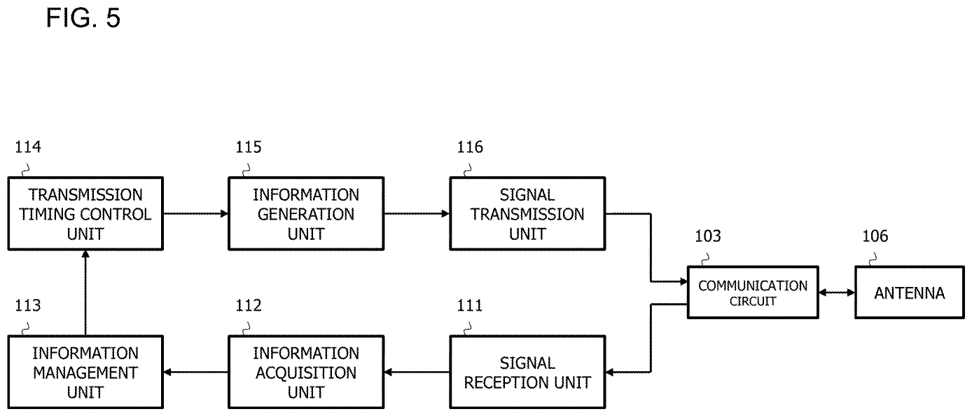

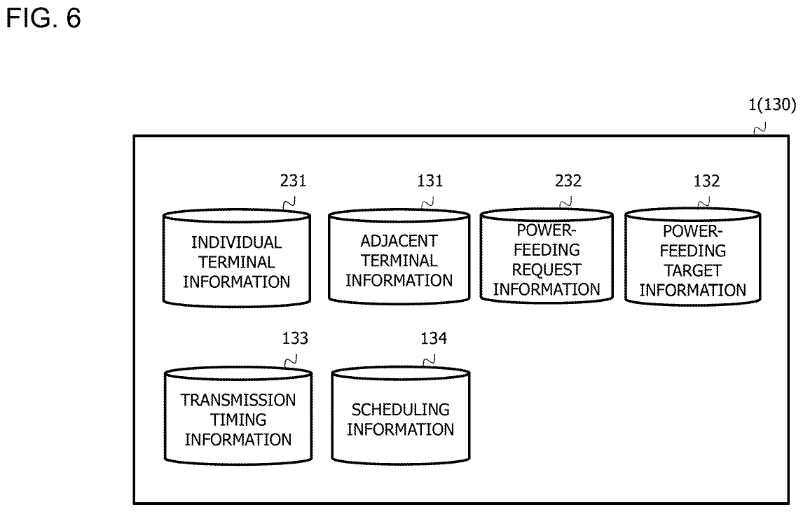

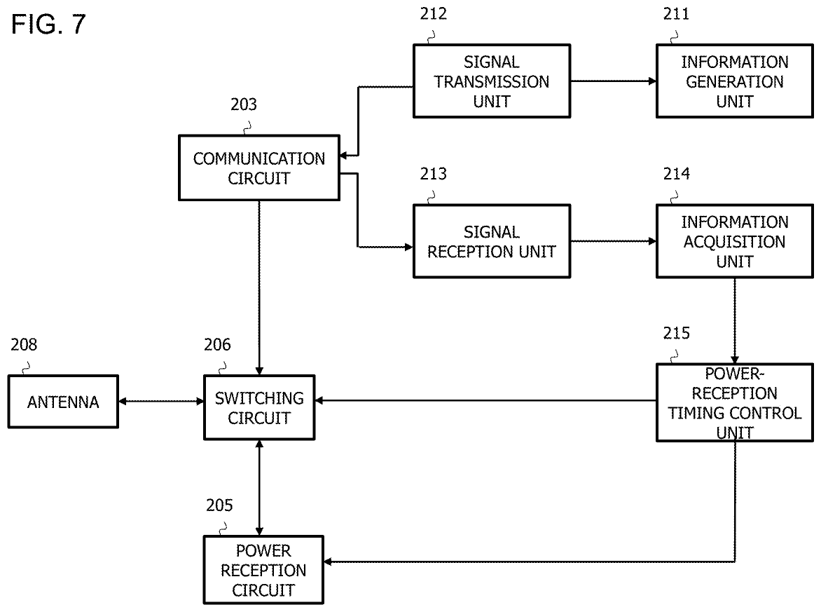

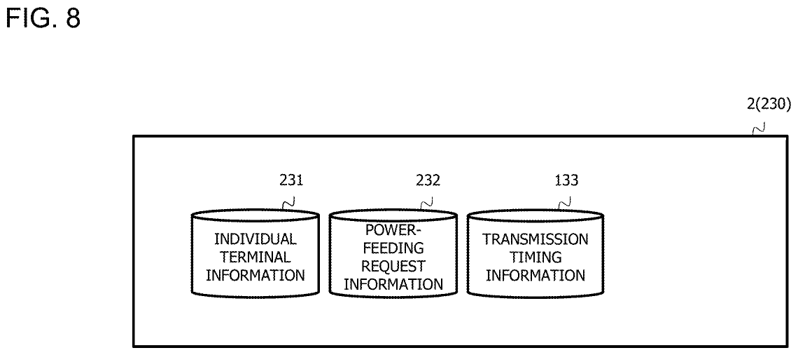

Next, functions of the wireless communication system 10 in the first embodiment are described. FIG. 5 is a view for describing functions of the base station device 1 in the first embodiment. Further, FIG. 6 is a view for describing information stored in the information storage area 130 in the first embodiment. Further, FIG. 7 is a view for describing functions of the terminal device 2 in the first embodiment. Further, FIG. 8 is a view for describing information stored in the information storage area 230 in the first embodiment.

### Functions of Base Station Device

First, functions of the base station device 1 are described. As illustrated in FIG. 5, the base station device 1, for example, implements various functions including a signal reception unit 111, an information acquisition unit 112, an information management unit 113, a transmission timing control unit 114, an information generation unit 115, and a signal transmission unit 116 by organic cooperation between hardware such as the CPU 101 or the memory 102 and the program.

Further, as illustrated in FIG. 6, in the information storage area 130, for example, individual terminal information 231, neighboring terminal information 131, power-feeding request information 232, power-feeding target information 132, transmission timing information 133, and scheduling information 134 are stored.

The signal reception unit 111, for example, receives a signal transmitted from the terminal device 2 via the antenna 106.

The information acquisition unit 112, for example, acquires the individual terminal information 231 included in the signal received by the signal reception unit 111. The individual terminal information 231 is, for example, information indicating a position of the terminal device 2 that is a transmission source of the signal received by the signal reception unit 111. Specifically, the individual terminal information 231 is, for example, positioning information provided by a global positioning system (GPS) mounted on the terminal device 2 that is a transmission source of the signal received by the signal reception unit 111. Then, the information acquisition unit 112, for example, stores the acquired individual terminal information 231 into the information storage area 130.

Note that the information acquisition unit 112, for example, may acquire another piece of information as the individual terminal information 231, instead of the individual terminal information 231 included in the signal received by the signal reception unit 111, or together with the individual terminal information 231 included in the signal received by the signal reception unit 111. Specifically, the information acquisition unit 112, for example, may acquire information indicating a position (for example, a position measured by using direction propagation delay) of each terminal device 2 measured by the base station device 1, ZoneID corresponding to each terminal device 2, and the like, as the individual terminal information 231.

The information management unit 113, for example, generates the neighboring terminal information 131 from the individual terminal information 231 acquired by the information acquisition unit 112. The neighboring terminal information 131 is, for example, information indicating a group to which each terminal device 2 belongs. Then, the information management unit 113, for example, stores the generated neighboring terminal information 131 into the information storage area 130.

Specifically, the information management unit 113, for example, refers to the individual terminal information 231 (individual terminal information 231 for each terminal device 2) stored in the information storage area 130, and classifies the terminal devices 2 into one or more groups such that one or more terminal devices 2 whose positional relationship satisfies a predetermined condition are included in the same group. Then, the information management unit 113 generates information indicating the terminal device 2 included in each of the one or more groups, as the neighboring terminal information 131.

More specifically, the information management unit 113, for example, refers to the individual terminal information 231 (individual terminal information 231 for each terminal device 2) stored in the information storage area 130, and classifies the terminal devices 2 into one or more groups such that a distance to at least any of the terminal devices 2 included in the same group is equal to or less than a predetermined distance. Then, the information management unit 113 generates information indicating the terminal device 2 included in each of the one or more groups, as the neighboring terminal information 131.

Note that, in a case where transmission and reception (exchange) of information for each terminal device 2 is performed between the base station device 1 and another base station device (not illustrated), the information acquisition unit 112, for example, may acquire a cell ID for identifying a cell in which each terminal device 2 is located, as the individual terminal information 231. Then, in this case, the information management unit 113, for example, may classify the terminal devices 2 located in any of the plurality of cells corresponding to the base station device 1 and another base station device, respectively, into one or more groups, and generate information indicating the terminal device 2 included in each of the classified one or more groups, as the neighboring terminal information 131.

The transmission timing control unit 114, for example, refers to the neighboring terminal information 131 generated by the information management unit 113, and designates the neighboring terminal device 2 (one or more neighboring terminal devices 2) corresponding to each terminal device 2, for each terminal device 2. Specifically, for each terminal device 2, the transmission timing control unit 114, for example, designates another terminal device 2 that is included in the same group as the terminal device 2 and is other than the terminal device 2, as the neighboring terminal device 2. Then, for each terminal device 2, the transmission timing control unit 114, for example, refers to the scheduling information 134 indicating a result of scheduling (wireless resource allocation control) performed in association with each terminal device 2, and specifies a transmission timing of a signal (first signal) from the designated neighboring terminal device 2 to the base station device 1.

The information generation unit 115, for example, generates the transmission timing information 133 indicating the transmission timing specified by the transmission timing control unit 114 for each terminal device 2. Then, the information generation unit 115, for example, stores the generated transmission timing information 133 into the information storage area 130.

The signal transmission unit 116, for example, for each terminal device 2, transmits a signal (second signal) including the transmission timing information 133 corresponding to each terminal device 2 in the transmission timing information 133 generated by the information generation unit 115, via the antenna 106.

Specifically, the signal transmission unit 116, for example, informs each of one or more groups classified by the information management unit 113 of a signal including the transmission timing information 133 corresponding to each terminal device 2 included in each of the one or more groups. Further, the signal transmission unit 116, for example, for each terminal device 2, transmits a signal including the transmission timing information 133 corresponding to each terminal device 2 by using an individual channel (for example, physical downlink control channel (PDCCH)) connected to each terminal device 2.

Further, the information acquisition unit 112, for example, acquires the power-feeding request information 232 included in the signal received by the signal reception unit 111. The power-feeding request information 232 is, for example, information indicating whether or not the terminal device 2 requests reception of power (first power) wirelessly fed. Then, the information acquisition unit 112, for example, stores the acquired power-feeding request information 232 into the information storage area 130.

Further, the information management unit 113, for example, generates the power-feeding target information 132 from the power-feeding request information 232 acquired by the information acquisition unit 112. The power-feeding target information 132 is, for example, information indicating each terminal device 2 that needs to be wirelessly fed with power. Then, the information management unit 113, for example, stores the generated power-feeding target information 132 into the information storage area 130.

### Functions of Terminal Device

Next, functions of the terminal device 2 are described. As illustrated in FIG. 7, the terminal device 2, for example, implements various functions including an information generation unit 211, a signal transmission unit 212 (hereinafter also simply referred to as a transmission unit), a signal reception unit 213 (hereinafter also simply referred to as a reception unit), an information acquisition unit 214, and a power-reception timing control unit 215 (hereinafter also simply referred to as a control unit) by organic cooperation between hardware such as the CPU 201 or the memory 202 and the program 210.

Further, as illustrated in FIG. 8, in the information storage area 230, for example, the individual terminal information 231, the power-feeding request information 232, and the transmission timing information 133 are stored.

The information generation unit 211, for example, generates the individual terminal information 231. Then, the information generation unit 211, for example, stores the generated individual terminal information 231 into the information storage area 230.

The signal transmission unit 212, for example, transmits a signal (hereinafter also referred to as a third signal) including the individual terminal information 231 generated by the information generation unit 211, to the base station device 1 via the antenna 208.

Specifically, the signal transmission unit 212, for example, transmits a signal including the individual terminal information 231 generated by the information generation unit 211 by using an individual channel (for example, physical uplink control channel (PUCCH)) connected to the base station device 1.

Further, the information generation unit 211, for example, generates the power-feeding request information 232. Then, the information generation unit 211, for example, stores the generated power-feeding request information 232 into the information storage area 230.

Further, the signal transmission unit 212, for example, transmits a signal (hereinafter also referred to as a fourth signal) including the power-feeding request information 232 generated by the information generation unit 211, to the base station device 1 via the antenna 208.

Specifically, the signal transmission unit 212, for example, incorporates the power-feeding request information 232 generated by the information generation unit 211 into a message or a signal for transmitting UE Capability Information, and transmits the message or the signal to the base station device 1. Note that the message for transmitting UE Capability Information is, for example, a radio resource control (RRC) message. Further, the signal transmission unit 212, for example, transmits another message (message other than RRC message) to which the power-feeding request information 232 generated by the information generation unit 211 is added, to the base station device 1.

The signal reception unit 213, for example, receives a signal (second signal) transmitted from the base station device 1 via the antenna 208.

The information acquisition unit 214, for example, acquires the transmission timing information 133 included in the signal received by the signal reception unit 213. Then, the information acquisition unit 214, for example, stores the acquired transmission timing information 133 into the information storage area 130.

The power-reception timing control unit 215, for example, controls the switching circuit 206 such that power fed wirelessly can be received at the transmission timing indicated by the transmission timing information 133 acquired by the information acquisition unit 214.

Specifically, at the transmission timing, the power-reception timing control unit 215, for example, controls the switching circuit 206 such that a destination of connection of the signal received via the antenna 208 is the power reception circuit 205. Meanwhile, at timings other than the transmission timing, the power-reception timing control unit 215, for example, controls the switching circuit 206 such that a destination of connection of the signal received via the antenna 208 is the communication circuit 203.

Further, the power-reception timing control unit 215, for example, causes the rectifier circuit 205a and the DC-DC converter 205b to be fed with power charged in the battery 205c at the transmission timing.

Further, the power-reception timing control unit 215, for example, adjusts the directivity of the antenna 208 such that the antenna 208 is directed in a direction in which the neighboring terminal device 2 is located, at the transmission timing. Note that, in a case where the terminal device 2 includes a plurality of antennas 208, the power-reception timing control unit 215, for example, may select the antenna 208 having a directivity in a direction in which the neighboring terminal device 2 is located.

### Sequence Chart of Power-Feeding Control Process in First Embodiment

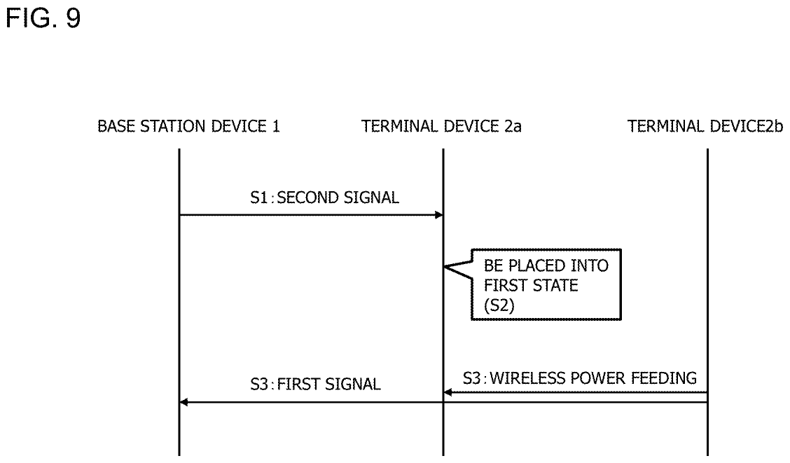

Next, a sequence chart of a power-feeding control process in the first embodiment is described. FIG. 9 is a sequence chart of the power-feeding control process in the first embodiment.

As illustrated in FIG. 9, the terminal device 2a, for example, receives a signal (second signal) including information on a timing (transmission timing) at which the terminal device 2b transmits a signal (first signal) to the base station device 1, from the base station device 1 (S1).

Then, the terminal device 2a, for example, places the terminal device 2 at the transmission timing into a state (first state) in which the terminal device 2 can receive power (first power) fed wirelessly, in response to reception of the second signal transmitted from the base station device 1 (S2).

Subsequently, the terminal device 2a, for example, receives power of the signal (first signal) transmitted from terminal device 2b to the base station device 1, at the transmission timing (S3).

That is, the terminal device 2 in the present embodiment, for example, receives power of the signal transmitted from the neighboring terminal device 2 located in the vicinity of each terminal device 2, instead of power of the signal transmitted from the base station device 1, or together with power of the signal transmitted from the base station device 1, and is charged by using the received power.

Thus, the terminal device 2 in the present embodiment, for example, can stably receive power regardless of a distance to the base station device 1, in other words, regardless of a degree of propagation loss of power of the transmission signal from the base station device 1. Therefore, the wireless communication system 10 in the present embodiment, for example, can efficiently perform wireless power feeding to the terminal device 2.

### Details of Power-Feeding Control Process in First Embodiment

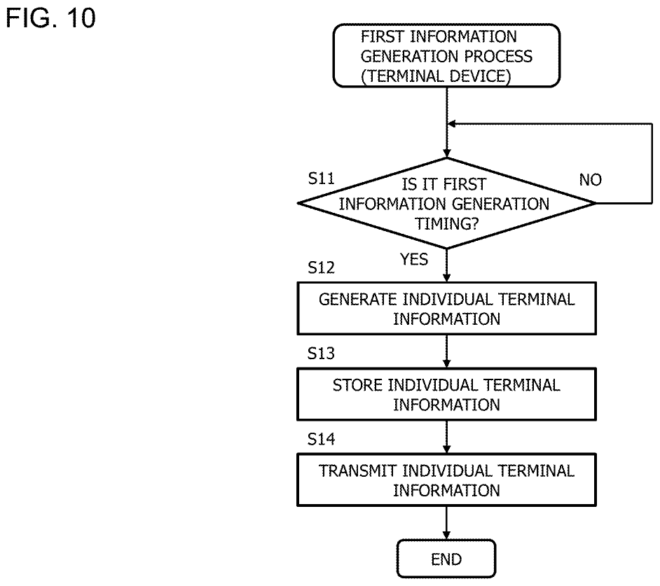

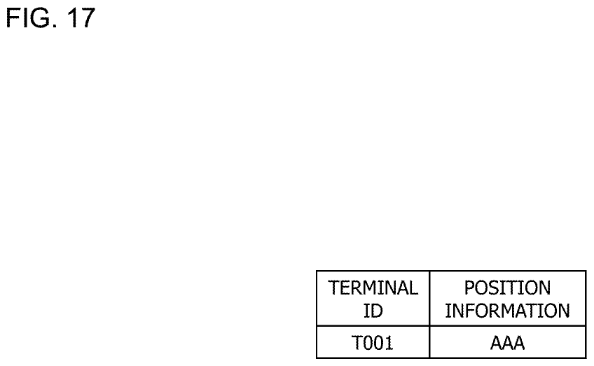

Next, details of the power-feeding control process in the first embodiment are described. FIG. 10 to FIG. 16 are flowcharts for describing the details of the power-feeding control process in the first embodiment. Further, FIG. 17 to FIG. 28 are views for describing the power-feeding control process in the first embodiment.

### First Information Generation Process

First, description is made about a process (hereinafter also referred to as a first information generation process of generating the individual terminal information 231 in the power-feeding control process performed in the terminal device 2. FIG. 10 is a view for describing the first information generation process.

As illustrated in FIG. 10, the information generation unit 211, for example, waits until a first information generation timing comes (NO in S11). The first information generation timing may be, for example, a regular timing such as every frame.

Then, when the first information generation timing comes (YES in S11), the information generation unit 211, for example, generates the individual terminal information 231 (S12).

Subsequently, the information generation unit 211, for example, stores the individual terminal information 231 generated in the process of S12 into the information storage area 230 (S13). A specific example of the individual terminal information 231 is described below.

### Specific Example of Individual Terminal Information

FIG. 17 is a view for describing a specific example of the individual terminal information 231.

The individual terminal information 231 illustrated in FIG. 17, for example, includes, as items thereof, “TERMINAL ID” in which information for identifying each terminal device 2 is set and “POSITION INFORMATION” in which position information of each terminal device 2 is set.

Specifically, for example, in the individual terminal information 231 illustrated in FIG. 17, “T001” is set as “TERMINAL ID”, and “AAA” is set as “POSITION INFORMATION”.

Referring back to FIG. 10, the signal transmission unit 212, for example, transmits a signal including the individual terminal information 231 generated in the process of S12, to the base station device 1 via the antenna 208 (S14).

### Second Information Generation Process

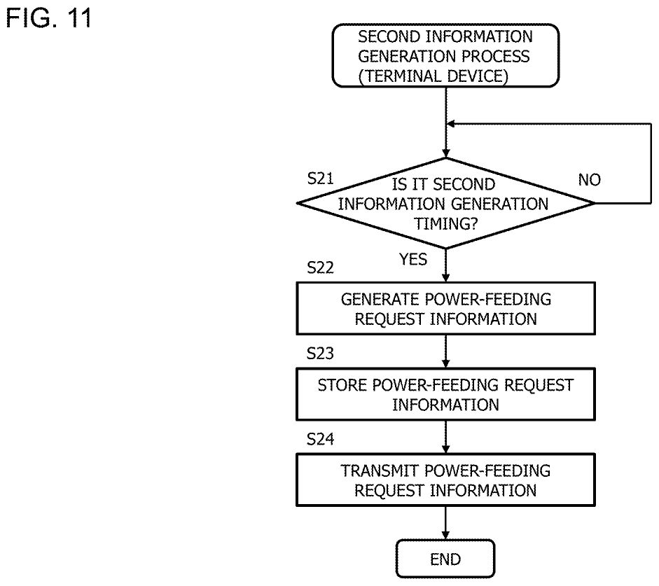

Next, description is made about a process (hereinafter also referred to as a second information generation process) of generating the power-feeding request information 232 in the power-feeding control process performed in the terminal device 2. FIG. 11 is a view for describing the second information generation process.

As illustrated in FIG. 11, the information generation unit 211, for example, waits until a second information generation timing comes (NO in S21). The second information generation timing may be, for example, a regular timing such as every frame.

Then, when the second information generation timing comes (YES in S21), the information generation unit 211, for example, generates the power-feeding request information 232 (S22).

Subsequently, the information generation unit 211, for example, stores the power-feeding request information 232 generated in the process of S22 into the information storage area 230 (S23). A specific example of the power-feeding request information 232 is described below.

### Specific Example of Power-Feeding Request Information

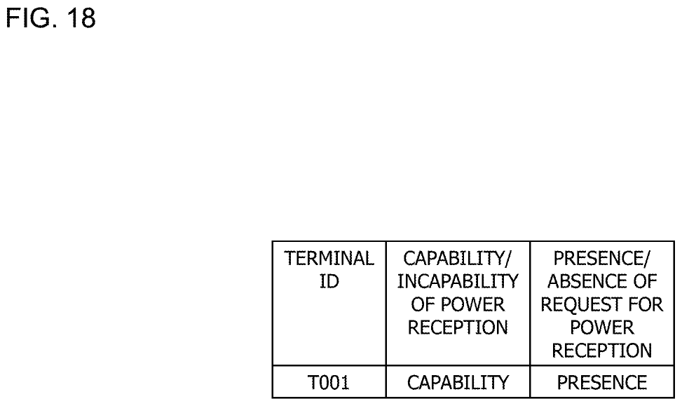

FIG. 18 is a view for describing a specific example of the power-feeding request information 232.

The power-feeding request information 232 illustrated in FIG. 18, for example, includes, as items thereof, “TERMINAL ID” in which information for identifying each terminal device 2 is set, “CAPABILITY/INCAPABILITY OF POWER RECEPTION” in which information indicating whether or not each terminal device 2 can receive power by wireless power feeding (whether or not each terminal device 2 includes the power reception circuit 205 or the like) is set, and “PRESENCE/ABSENCE OF REQUEST FOR POWER RECEPTION” in which information indicating whether or not each terminal device 2 requests power reception by wireless power feeding is set.

Specifically, in the power-feeding request information 232 illustrated in FIG. 18, for example, “T001” is set as “TERMINAL ID”, “CAPABILITY” is set as “CAPABILITY/INCAPABILITY OF POWER RECEPTION”, and “PRESENCE” is set as “PRESENCE/ABSENCE OF REQUEST FOR POWER RECEPTION”.

That is, the power-feeding request information 232 illustrated in FIG. 18, for example, indicates that the terminal device 2 whose terminal ID is T001 has a capability of receiving power by wireless power feeding and requests power reception.

Referring back to FIG. 11, the signal transmission unit 212, for example, transmits a signal including the power-feeding request information 232 generated in the process of S22, to the base station device 1 via the antenna 208 (S24).

Meanwhile, in a case where the power-feeding request information 232 generated in the process of S22 is added to a RRC message and transmitted, the signal transmission unit 212, for example, may convert each of the information set in “CAPABILITY/INCAPABILITY OF POWER RECEPTION” and the information set in “PRESENCE/ABSENCE OF REQUEST FOR POWER RECEPTION” in the power-feeding request information 232, into one-bit information and add the information to the RRC message. Further, in this case, the signal transmission unit 212, for example, may convert either the information set in “CAPABILITY/INCAPABILITY OF POWER RECEPTION” or the information set in “PRESENCE/ABSENCE OF REQUEST FOR POWER RECEPTION” in the power-feeding request information 232, into one-bit information and add the information to the RRC message.

### Third Information Generation Process

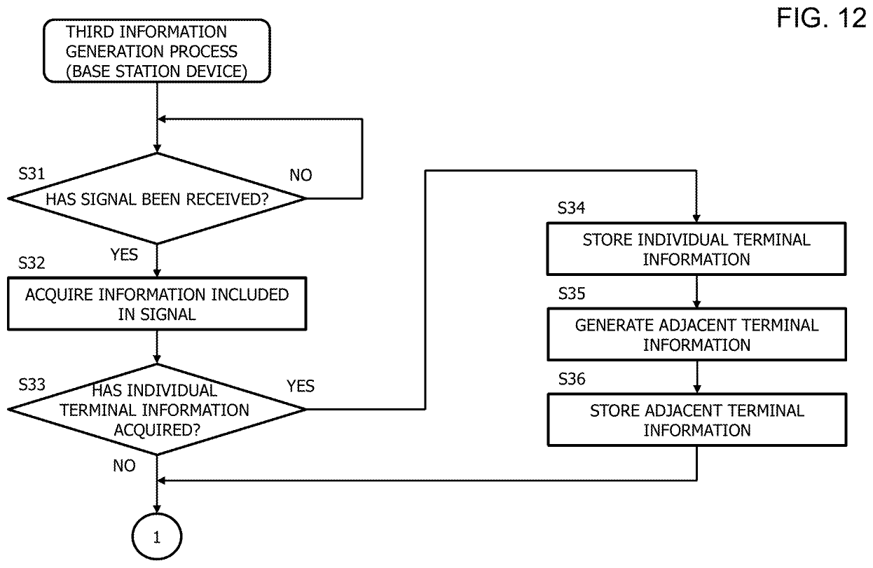

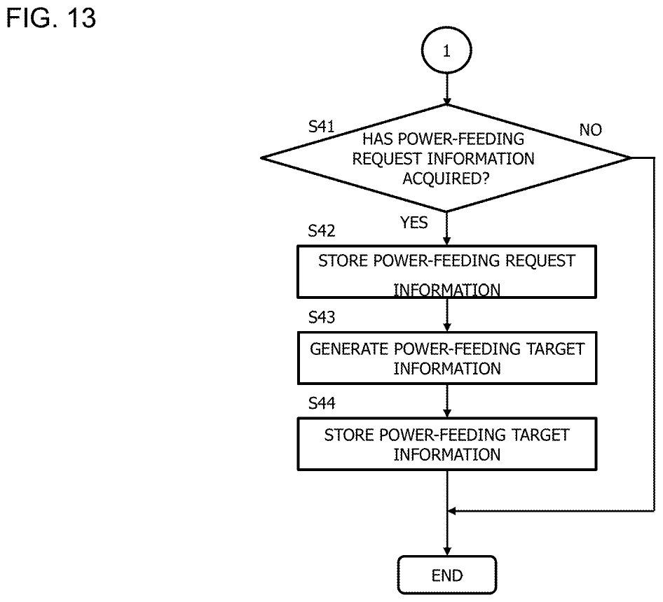

Next, description is made about a process (hereinafter also referred to as a third information generation process) of generating the neighboring terminal information 131 and the power-feeding target information 132 in the power-feeding control process performed in the base station device 1. FIG. 12 and FIG. 13 are flowcharts for describing the third information generation process.

As illustrated in FIG. 12, the signal reception unit 111, for example, waits until a signal transmitted from the terminal device 2 via the antenna 106 is received (NO in S31).

Then, when the signal transmitted from the terminal device 2 is received (YES in S31), the information acquisition unit 112, for example, acquires information included in the received signal (S32).

Subsequently, the information acquisition unit 112, for example, determines whether or not the information received in the process of S32 includes the individual terminal information 231 (S33).

As a result of determination, when it is determined that the information received in the process of S32 includes the individual terminal information 231 (YES in S33), the information acquisition unit 112, for example, stores the individual terminal information 231 received in the process of S32 into the information storage area 130 (S34).

Then, the information management unit 113, for example, generates (updates) the neighboring terminal information 131 from the individual terminal information 231 (the individual terminal information 231 for each terminal device 2) stored in the information storage area 130 (S35).

Specifically, the information management unit 113, for example, refers to the individual terminal information 231 (individual terminal information 231 for each terminal device 2) stored in the information storage area 130, and classifies the terminal devices 2 into one or more groups such that one or more terminal devices 2 whose positional relationship satisfies a predetermined condition are included in the same group. Then, the information management unit 113 generates information indicating the terminal device 2 included in each of the one or more groups, as the neighboring terminal information 131.

More specifically, the information management unit 113, for example, refers to the individual terminal information 231 (individual terminal information 231 for each terminal device 2) stored in the information storage area 130, and classifies the terminal devices 2 into one or more groups such that a distance to at least any of the terminal devices 2 included in the same group is equal to or less than a predetermined distance. Then, the information management unit 113 generates information indicating the terminal device 2 included in each of the one or more groups, as the neighboring terminal information 131.

After that, the information management unit 113, for example, stores the neighboring terminal information 131 generated in the process of S35 into the information storage area 130 (S36).

Note that the information management unit 113, for example, may be designed so as not to perform the process of S35 and the process of S36 every time the process of S34 is performed. Specifically, the information management unit 113, for example, may perform the process of S35 and the process of S36 every time the process of S34 is performed a predetermined number of times. A specific example of the neighboring terminal information 131 is described below.

### Specific Example of Neighboring Terminal Information

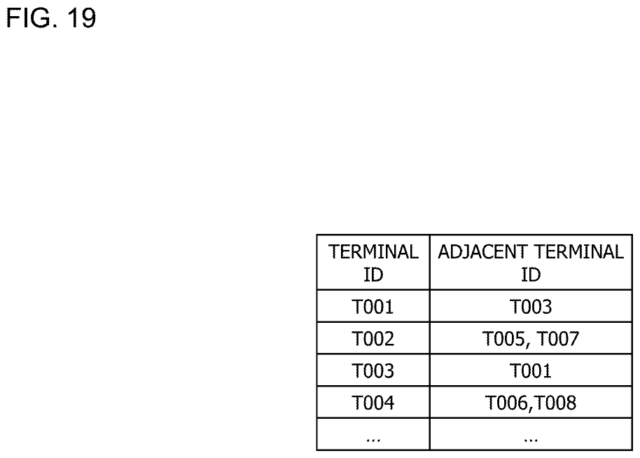

FIG. 19 is a view for describing a specific example of the neighboring terminal information 131.

The neighboring terminal information 131 illustrated in FIG. 19, for example, includes, as items thereof, “TERMINAL ID” in which information for identifying each terminal device 2 is set, and “NEIGHBORING TERMINAL ID” in which information for identifying another terminal device 2 (neighboring terminal device 2) that is included in the same group as each terminal device 2 and is other than each terminal device 2 is set. Note that the information set in “TERMINAL ID” may be, for example, international mobile equipment identity (IMEI) that is a unique number of the terminal device 2. Alternatively, the information set in “TERMINAL ID” may be, for example, temporary mobile subscriber identity (TMSI) that is a number allocated by the base station device 1.

Specifically, in information in the first row of the neighboring terminal information 131 illustrated in FIG. 19, for example, “T001” is set as “TERMINAL ID”, and “T003” is set as “NEIGHBORING TERMINAL ID”.

That is, the information in the first row of the neighboring terminal information 131 illustrated in FIG. 19, for example, indicates that the terminal device 2 whose “TERMINAL ID” is “T001” and the terminal device 2 whose “TERMINAL ID” is “T003” are classified into the same group.

Further, in information in the second row of the neighboring terminal information 131 illustrated in FIG. 19, for example, “T002” is set as “TERMINAL ID”, and “T005” and “T007” are set as “NEIGHBORING TERMINAL ID”.

That is, the information in the second row of the neighboring terminal information 131 illustrated in FIG. 19, for example, indicates that the terminal device 2 whose “TERMINAL ID” is “T002”, the terminal device 2 whose “TERMINAL ID” is “T005”, and the terminal device 2 whose “TERMINAL ID” is “T007” are classified into the same group. Description of other information included in FIG. 19 is omitted.

Referring back to FIG. 12, in the process of S33, when it is determined that the information received in the process of S32 does not include the individual terminal information 231 (NO in S33), the information acquisition unit 112, for example, determines whether or not the information received in the process of S32 includes the power-feeding request information 232 as illustrated in FIG. 13 (S41). Note that the information acquisition unit 112, for example, performs the process of S41 also after the process of S36 in the same manner.

As a result of determination, when it is determined that the information received in the process of S32 includes the power-feeding request information 232 (YES in S41), the information acquisition unit 112, for example, stores the power-feeding request information 232 received in the process of S32 into the information storage area 130 (S42).

Then, the information management unit 113, for example, generates the power-feeding target information 132 from the power-feeding request information 232 stored in the information storage area 130 (S43).

Specifically, the information management unit 113, for example, generates the power-feeding target information 132 by extracting information in which “PRESENCE” is set in “PRESENCE/ABSENCE OF REQUEST FOR POWER RECEPTION” among the power-feeding request information 232 stored in the information storage area 130.

After that, the information management unit 113, for example, stores the power-feeding target information 132 generated in the process of S43 into the information storage area 130 (S44).

Note that the information management unit 113, for example, may be designed so as not to perform the process of S43 and the process of S44 every time the process of S42 is performed. Specifically, the information management unit 113, for example, may perform the process of S43 and the process of S44 every time the process of S42 is performed a predetermined number of times. A specific example of the power-feeding target information 132 is described below.

### Specific Example of Power-Feeding Target Information

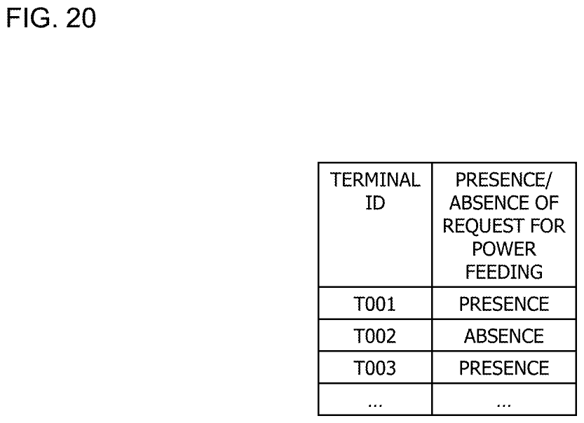

FIG. 20 is a view for describing a specific example of the power-feeding target information 132.

The power-feeding target information 132 illustrated in FIG. 20, for example, includes, as items thereof, “TERMINAL ID” and “PRESENCE/ABSENCE OF REQUEST FOR POWER RECEPTION” among the items included in the power-feeding request information 232 described with reference to FIG. 18.

Specifically, in information in the first row of the power-feeding target information 132 illustrated in FIG. 20, for example, “T001” is set as “TERMINAL ID”, and “PRESENCE” is set as “PRESENCE/ABSENCE OF POWER-FEEDING TARGET”.

That is, the information in the first row of the power-feeding target information 132 illustrated in FIG. 20, for example, indicates that there is a need to perform wireless power feeding to the terminal device 2 whose “TERMINAL ID” is “T001”.

Further, in information in the second row of the power-feeding target information 132 illustrated in FIG. 20, for example, “T002” is set as “TERMINAL ID”, and “ABSENCE” is set as “PRESENCE/ABSENCE OF POWER-FEEDING TARGET”.

That is, the information in the second row of the power-feeding target information 132 illustrated in FIG. 20, for example, indicates that there is no need to perform wireless power feeding to the terminal device 2 whose “TERMINAL ID” is “T002”. Description of other information included in FIG. 20 is omitted.

Referring back to FIG. 12, in the process of S41, when it is determined that the information received in the process of S32 does not include the power-feeding request information 232 (NO in S41), the information acquisition unit 112 and the information management unit 113, for example, do not perform the processes in S42 to S44.

### Timing Transmission Process

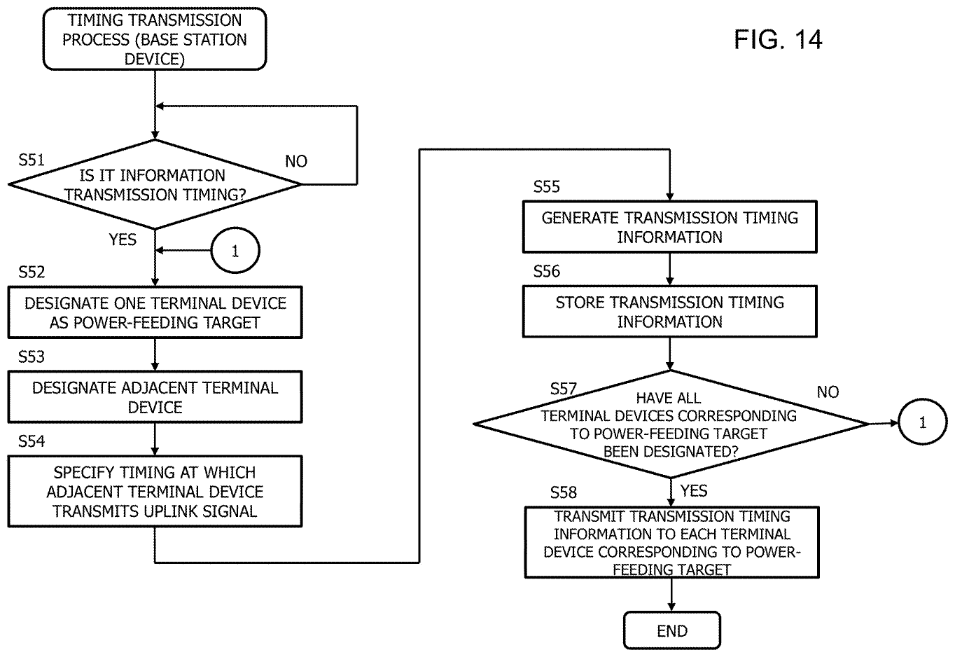

Next, description is made about a process (hereinafter also referred to as a timing transmission process) of transmitting the transmission timing information 133 to the terminal device 2 in the power-feeding control process performed in the base station device 1. FIG. 14 is a view for describing the timing transmission process.

As illustrated in FIG. 14, the transmission timing control unit 114, for example, waits until an information transmission timing comes (NO in S51). The information transmission timing may be, for example, a regular timing such as every frame.

Then, when the information transmission timing comes (YES in S51), the transmission timing control unit 114, for example, refers to the power-feeding target information 132 stored in the information storage area 130, and designates one terminal device 2 (hereinafter also referred to as a target terminal device 2) that needs wireless power feeding (S52).

Specifically, the transmission timing control unit 114, for example, designates one terminal device 2 corresponding to the information in which “PRESENCE” is set in “PRESENCE/ABSENCE OF REQUEST FOR POWER RECEPTION” among the power-feeding target information 132 stored in the information storage area 130.

Subsequently, the transmission timing control unit 114, for example, refers to the neighboring terminal information 131 stored in the information storage area 130, and designates the neighboring terminal device 2 corresponding to the terminal device 2 designated in the process of S52 (S53).

Specifically, in information described in FIG. 19 in the first row of the neighboring terminal information 131, “T001” is set as the “TERMINAL ID” and “T003” is set as “NEIGHBORING TERMINAL ID”. Thus, for example, when the terminal ID of the terminal device 2 designated in the process of S52 is T001, the transmission timing control unit 114, for example, designates the terminal device 2 whose terminal ID is T003, as the neighboring terminal device 2 in the process of S53.

Further, the transmission timing control unit 114, for example, refers to the scheduling information 134 stored in the information storage area 130, and specifies a timing (transmission timing) at which the neighboring terminal device 2 designated in the process of S53 transmits a signal to the base station device 1 (S54).

Meanwhile, in a case where a plurality of neighboring terminal devices 2 are designated in the process of S53, the information generation unit 115, for example, specifies a timing (transmission timing) at which any of the plurality of neighboring terminal devices 2 designated in the process of S53 transmits a signal to the base station device 1.

After that, the information generation unit 115, for example, generates the transmission timing information 133 indicating the transmission timing specified in the process of S54 (S55).

Then, the information generation unit 115, for example, stores the generated transmission timing information 133 into the information storage area 130 (S56). A first specific example of the transmission timing information 133 is described below.

### Specific Example (1) of Transmission Timing Information

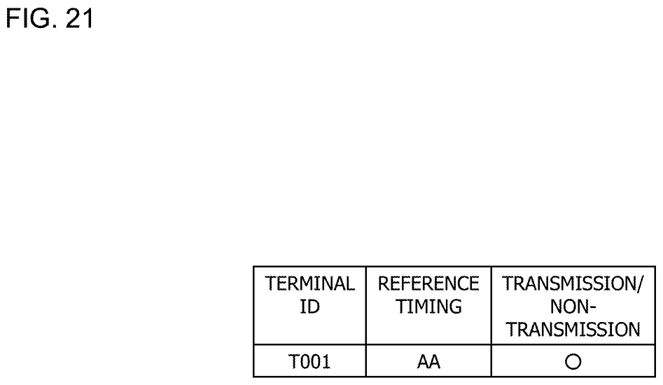

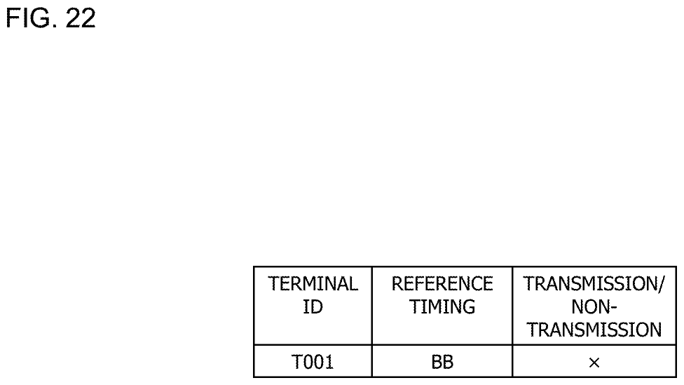

FIG. 21 and FIG. 22 are views for describing specific examples of the transmission timing information 133.

The transmission timing information 133 illustrated in FIG. 21 and the like, for example, includes, as items thereof, “TERMINAL ID” in which information for identifying each terminal device 2 is set, and “REFERENCE TIMING” in which a timing at which the transmission timing information 133 is transmitted to each terminal device 2 is set. Further, the transmission timing information 133 illustrated in FIG. 21 and the like, for example, includes, as an item thereof, “TRANSMISSION/NON-TRANSMISSION” in which information indicating whether or not the neighboring terminal device 2 corresponding to each terminal device 2 transmits a signal to the base station device 1 at a timing that comes after a predetermined time period following a timing set in “REFERENCE TIMING”, is set. Note that the above-described predetermined time period may be, for example, a predetermined time period such as several frames.

Specifically, in the transmission timing information 133 illustrated in FIG. 21, for example, “T001” is set as “TERMINAL ID”, “AA” is set as “REFERENCE TIMING”, and “○” is set as “TRANSMISSION/NON-TRANSMISSION”.

That is, the transmission timing information 133 illustrated in FIG. 21, for example, indicates that at least any of the neighboring terminal devices 2 corresponding to the terminal device 2 whose “TERMINAL ID” is “T001” transmits a signal to the base station device 1 at a timing that comes after a predetermined time period following “AA”.

In other words, the transmission timing information 133 illustrated in FIG. 21, for example, indicates that the terminal device 2 whose “TERMINAL ID” is “T001” can be charged (charged by wireless power feeding) at a timing that comes after a predetermined time period following “AA”.

Further, in the transmission timing information 133 illustrated in FIG. 22, for example, “T001” is set as “TERMINAL ID”, “BB” is set as “REFERENCE TIMING”, and “×” is set as “TRANSMISSION/NON-TRANSMISSION”.

That is, the transmission timing information 133 illustrated in FIG. 22, for example, indicates that any of the neighboring terminal devices 2 corresponding to the terminal device 2 whose “TERMINAL ID” is “T001” does not transmit a signal to the base station device 1 at a timing that comes after a predetermined time period following “BB”.

In other words, the transmission timing information 133 illustrated in FIG. 22, for example, indicates that the terminal device 2 whose “TERMINAL ID” is “T001” fails to be charged (charged by wireless power feeding) at a timing that comes after a predetermined time period following “BB”.

Referring back to FIG. 14, the information generation unit 115, for example, determines whether or not all the target terminal devices 2 have been designated in the process of S52 (S57).

As a result of determination, when it is determined that all the target terminal devices 2 have not been designated in the process of S52 (NO in S57), the information generation unit 115, for example, performs the processes of S52 and its subsequent steps again.

On the other hand, when it is determined that all the target terminal devices 2 have been designated in the process of S52 (YES in S57), the signal transmission unit 116, for example, transmits the transmission timing information 133 corresponding to each of the target terminal devices 2 designated in the process of S52, to each terminal device 2 (S58).

### Timing Reception Process

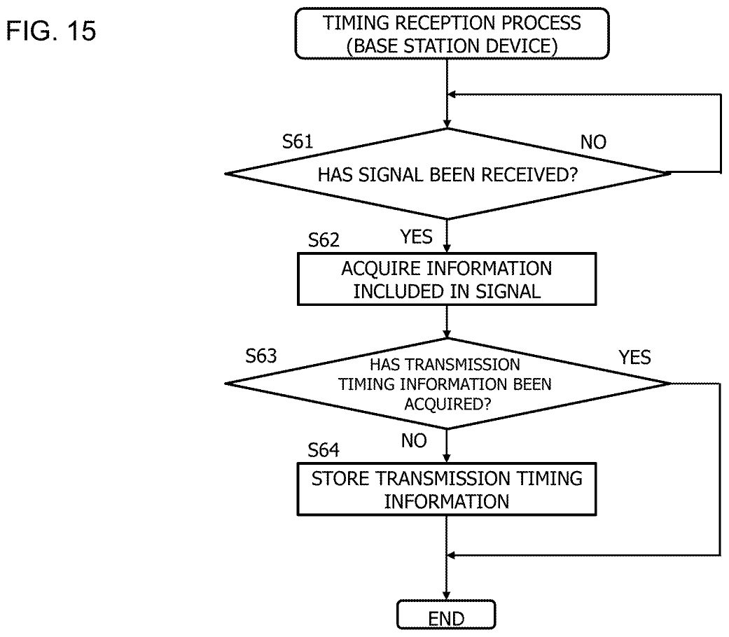

Next, description is made about a process (hereinafter also referred to as a timing reception process) of receiving the transmission timing information 133 transmitted from the base station device 1 in the power-feeding control process performed in the terminal device 2. FIG. 15 is a view for describing the timing reception process.

As illustrated in FIG. 15, the signal reception unit 213, for example, waits until a signal transmitted from the terminal device 2 via the antenna 106 is received (NO in S61).

Then, when the signal transmitted from the terminal device 2 is received (YES in S61), the information acquisition unit 214, for example, acquires information included in the received signal (S62).

Subsequently, the information acquisition unit 214, for example, determines whether or not the information acquired in the process of S62 includes the transmission timing information 133 (S63).

As a result of determination, when it is determined that the information acquired in the process of S62 includes the transmission timing information 133 (YES in S63), the information acquisition unit 214, for example, stores the transmission timing information 133 acquired in the process of S62 into the information storage area 230 (S64).

On the other hand, when it is determined that the information acquired in the process of S62 does not include the transmission timing information 133 (NO in S63), the information acquisition unit 214, for example, does not perform the process of S64.

### Switching Control Process

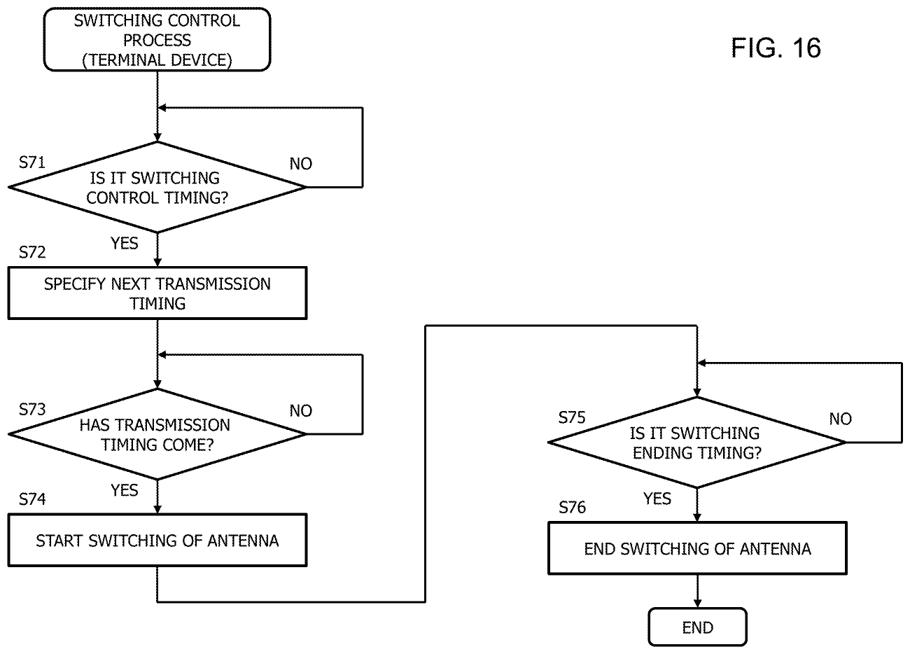

Next, description is made about a process (hereinafter also referred to as a switching control process) of switching a destination of connection of a signal received via the antenna 208 on the basis of the transmission timing information 133 in the power-feeding control process performed in the terminal device 2. FIG. 16 is a view for describing the switching control process.

As illustrated in FIG. 16, the power-reception timing control unit 215, for example, waits until a switching control timing comes (NO in S71). The switching control timing may be, for example, a timing at which it is determined that the information included in the signal received from the base station device 1 in the process of S63 is the transmission timing information 133. Further, the switching control timing may be, for example, a timing at which the transmission timing information 133 is stored into the information storage area 130 in the process of S64.

Then, when the switching control timing comes (YES in S71), the power-reception timing control unit 215, for example, specifies the next transmission timing (hereinafter also referred to as the next transmission timing) at which the neighboring terminal device 2 transmits a signal to the base station device 1 (S72).

Specifically, the power-reception timing control unit 215, for example, refers to the transmission timing information 133 stored in the information storage area 130, and designates information in which a timing set in “REFERENCE TIMING” is the earliest among the information in which “○” is set in “TRANSMISSION/NON-TRANSMISSION” and a timing set in “REFERENCE TIMING” is later than the current timing (for example, the timing at which the process of S72 is performed). Then, the power-reception timing control unit 215, for example, indicates a timing that comes after a predetermined time period following the timing set in “REFERENCE TIMING” of the designated information, as the next transmission timing.

Subsequently, the power-reception timing control unit 215, for example, waits until the next transmission timing specified in the process of S72 comes (NO in S73).

Then, when the next transmission timing specified in the process of S72 comes (YES in S73), the power-reception timing control unit 215, for example, switches the destination of connection of the signal received via the antenna 208, from the communication circuit 203 to the power reception circuit 205, by controlling the switching circuit 206 (S74).

That is, in this case, the power-reception timing control unit 215, for example, places the terminal device 2 into a state in which the terminal device 2 can be charged with power by the power reception circuit 205 (charged by using power of the signal received via the antenna 208).

Meanwhile, in the process of S74, for example, in a case where the power charged in the battery 205c is not fed to the rectifier circuit 205a or the DC-DC converter 205b, the power-reception timing control unit 215 performs control so as to start the power feeding.

After that, the power-reception timing control unit 215, for example, waits until a switching time period corresponding to the next transmission timing specified in the process of S72 elapses (NO in S75). The switching time period may be, for example, a time period (for example, one frame) corresponding to an interval of transmission of the transmission timing information 133 by the base station device 1.

Then, when the switching time period corresponding to the next transmission timing specified in the process of S72 elapses (YES in S75), the power-reception timing control unit 215, for example, switches the destination of connection of the signal received via the antenna 208, from the power reception circuit 205 to the communication circuit 203, by controlling the switching circuit 206 (S76).

Meanwhile, in the process of S76, for example, in a case where the power charged in the battery 205c is fed to the rectifier circuit 205a or the DC-DC converter 205b, the power-reception timing control unit 215 performs control so as to stop the power feeding.

Thus, the terminal device 2, for example, can reduce consumption of the power charged in the battery 205c. A first specific example of the timing reception process is described below.

### Specific Example (1) of Timing Reception Process

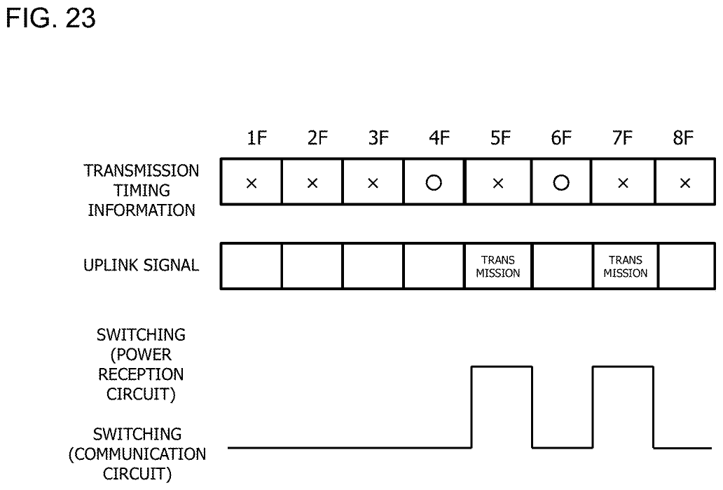

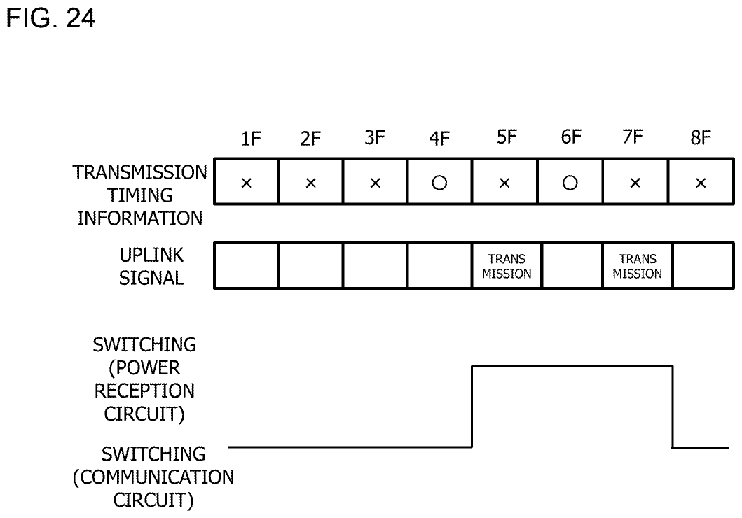

FIG. 23 and FIG. 24 are views for describing a specific example of the timing reception process in the power-feeding control process in the first embodiment.

In FIG. 23 and FIG. 24, “1F” to “8F” represent the first to eighth frames, respectively. Further, in FIG. 23 and FIG. 24, “TRANSMISSION TIMING INFORMATION” represents information set in “TRANSMISSION/NON-TRANSMISSION” of the transmission timing information 133 in each frame. Further, “UPLINK SIGNAL” represents whether or not the neighboring terminal device 2 transmits an uplink signal to the base station device 1 in each frame. Further, “SWITCHING (POWER RECEPTION CIRCUIT)” in FIG. 23 and FIG. 24 represents whether or not control over the switching circuit 206 for switching the destination of connection of the signal received via the antenna 208 to the power reception circuit 205 is performed in each frame. Further, “SWITCHING (COMMUNICATION CIRCUIT)” in FIG. 23 and FIG. 24 represents whether or not control over the switching circuit 206 for switching the destination of connection of the signal received via the antenna 208 to the communication circuit 203 is performed in each frame. Note that, hereinafter, the control over the switching circuit 206 for switching the destination of connection of the signal received via the antenna 208 from the communication circuit 203 to the power reception circuit 205 is also referred to as first switching, and the control over the switching circuit 206 for switching the destination of connection of the signal received via the antenna 208 from the power reception circuit 205 to the communication circuit 203 is also referred to as second switching.

Specifically, the example illustrated in FIG. 23, for example, indicates that, in each of the fourth frame and the sixth frame, the base station device 1 transmits the transmission timing information 133 in which “○” is set in “TRANSMISSION/NON-TRANSMISSION” to the terminal device 2, and in each of the fifth frame that is one frame after the fourth frame and the seventh frame that is one frame after the sixth frame, the neighboring terminal device 2 transmits an uplink signal to the base station device 1.

Thus, in this case, as illustrated in FIG. 23, the power-reception timing control unit 215, for example, performs the first switching on the switching circuit 206 in each of the fifth frame and the seventh frame.

In this respect, for example, when the power-reception timing control unit 215 performs the first switching on the switching circuit 206, the power-reception timing control unit 215 may be designed so as not to perform the second switching on the switching circuit 206 until the neighboring terminal device 2 further transmits an uplink signal to the base station device 1 a predetermined number of times. Note that the predetermined number of times here may be, for example, one or more times.

Specifically, as illustrated in FIG. 24, for example, when the power-reception timing control unit 215 performs the first switching on the switching circuit 206 in the fifth frame, the power-reception timing control unit 215 may be designed so as not to perform the second switching on the switching circuit 206 until the seventh frame in which the neighboring terminal device 2 transmits the next uplink signal.

As a result, the terminal device 2, for example, can reduce the number of times of the first switching and the second switching on the switching circuit 206. This enables the terminal device 2, for example, to reduce power consumption associated with control over the switching circuit 206.

Further, for example, also in a frame (for example, the sixth frame illustrated in FIG. 24) in which the neighboring terminal device 2 does not transmit an uplink signal to the base station device 1, when the base station device 1 transmits a downlink signal to the neighboring terminal device 2, the terminal device 2 can receive power of the downlink signal.

Note that, in a case where the terminal device 2 is incapable of receiving the transmission timing information 133 transmitted from the base station device 1 during the first switching on the switching circuit 206, the base station device 1, for example, may transmit the transmission timing information 133 including a timing (hereinafter also referred to as a re-switching timing) for performing the second switching on the switching circuit 206, to the terminal device 2. Then, after performing the first switching on the switching circuit 206, the power-reception timing control unit 215, for example, may perform the second switching on the switching circuit 206 at the re-switching timing indicated by the transmission timing information 133 received from the base station device 1.

As described above, the terminal device 2 in the present embodiment, for example, receives the second signal including information on the transmission timing at which the neighboring terminal device 2 transmits the first signal to the base station device 1, from the base station device 1. Then, the terminal device 2, for example, places the terminal device 2 at the transmission timing into the first state in which the terminal device 2 can receive the first power fed wirelessly, in response to reception of the second signal transmitted from the base station device 1.

That is, the terminal device 2 in the present embodiment, for example, receives power of the signal transmitted from the neighboring terminal device 2 located in the vicinity of each terminal device 2, instead of power of the signal transmitted from the base station device 1, or together with power of the signal transmitted from the base station device 1. Then, the terminal device 2, for example, is charged by using the received power. Further, the terminal device 2, for example, performs communication with the base station device 1 and the like by using the received power.

Note that, for example, a state in which the terminal device 2 does not receive the first power (for example, a state before being placed into the first state) is an example of the second state. Further, the second state can be also referred to as a state of being connected to the communication circuit.

Thus, the terminal device 2 in the present embodiment, for example, can stably receive power regardless of a distance to the base station device 1, in other words, regardless of a degree of propagation loss of power of the transmission signal from the base station device 1. Therefore, the wireless communication system 10 in the present embodiment, for example, can efficiently perform wireless power feeding to the terminal device 2.

Further, in the wireless communication system 10 in the present embodiment, for example, power is fed to the terminal device 2 that has transmitted the power-feeding request information 232, which enables power feeding to the terminal device 2 requesting power feeding without function addition or the like in the terminal device 2 not requesting power feeding.

Note that the wireless communication system 10 in the present embodiment, for example, may determine a method of charging each terminal device 2 according to the distance to the base station device 1. Specifically, the wireless communication system 10, for example, may charge the terminal device 2 located at a distance less than a predetermined threshold value from the base station device 1 by wireless power feeding using power of a signal from the base station device 1, and may charge the terminal device 2 located at a distance equal to or greater than the predetermined threshold value from the base station device 1 by wireless power feeding using power of a signal from the neighboring terminal device 2 (that is, wireless power feeding by the power-feeding control process according to the present embodiment).

This enables the wireless communication system 10, for example, to efficiently perform wireless power feeding to each of the plurality of terminal devices 2.

### Specific Example (2) of Transmission Timing Information

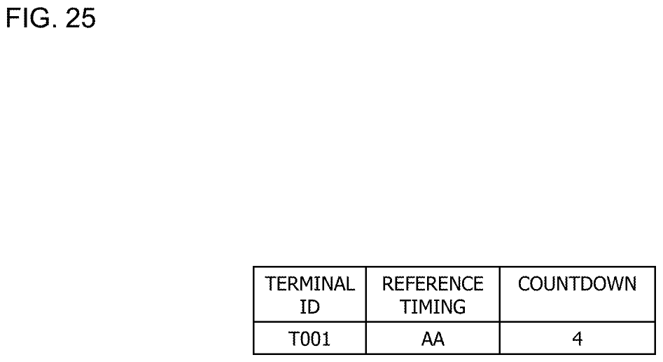

Next, a second specific example of the transmission timing information 133 is described. FIG. 25 is a view for describing a specific example of the transmission timing information 133.

The transmission timing information 133 illustrated in FIG. 25, for example, includes, as items thereof, “TERMINAL ID” in which information for identifying each terminal device 2 is set, and “REFERENCE TIMING” in which a timing at which the transmission timing information 133 is transmitted to each terminal device 2 is set. Further, the transmission timing information 133 illustrated in FIG. 25, for example, includes as an item thereof, “COUNTDOWN” in which a time period (for example, the number of frames) from a timing set in “REFERENCE TIMING” to the next transmission timing of the timing set in “REFERENCE TIMING” is set.

Specifically, in the transmission timing information 133 illustrated in FIG. 25, for example, “T001” is set as “TERMINAL ID”, “AA” is set as “TIMING”, and “4 (FRAMES)” is set as “COUNTDOWN”.

That is, the transmission timing information 133 illustrated in FIG. 25, for example, indicates that the neighboring terminal device 2 corresponding to the terminal device 2 whose “TERMINAL ID” is “T001” transmits a signal to the base station device 1 at a timing that comes after four frames following “AA”.

In other words, the transmission timing information 133 illustrated in FIG. 25, for example, indicates that the terminal device 2 whose “TERMINAL ID” is “T001” can be charged (charged by wireless power feeding) at a timing that comes after four frames following “AA”.

### Specific Example (2) of Timing Reception Process

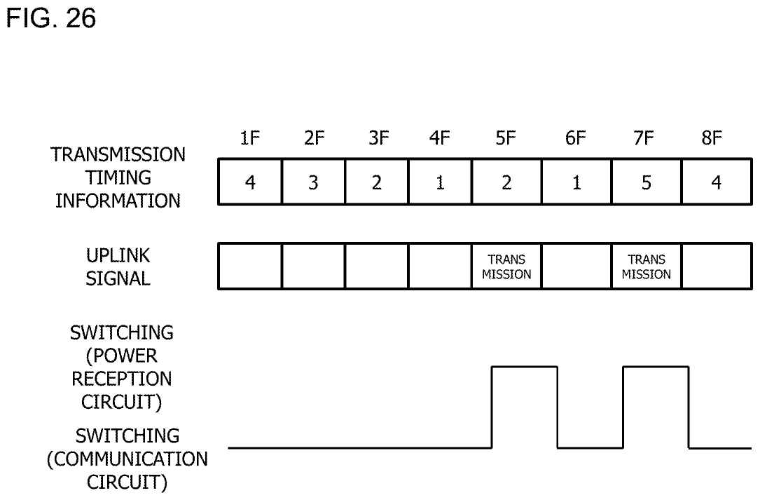

Next, a second specific example of the timing reception process is described. FIG. 26 is a view for describing a specific example of the timing reception process in the power-feeding control process in the first embodiment. Note that, in FIG. 26, “1F” to “8F”, “TRANSMISSION TIMING INFORMATION”, “UPLINK SIGNAL”, “SWITCHING (POWER RECEPTION CIRCUIT)”, and “SWITCHING (COMMUNICATION CIRCUIT)” are similar to those in FIG. 23.

The example illustrated in FIG. 26, for example, indicates that, in each of the fourth frame and the sixth frame, the base station device 1 transmits the transmission timing information 133 in which “1” is set in “COUNTDOWN”, to the neighboring terminal device 2, and in each of the fifth frame that is one frame after the fourth frame and the seventh frame that is one frame after the sixth frame (in other words, in each of frames in which “0” is set in “COUNTDOWN”), the neighboring terminal device 2 transmits an uplink signal to the base station device 1.

Thus, in this case, the power-reception timing control unit 215, for example, performs the first switching on the switching circuit 206 in each of the fifth frame and the seventh frame.

As a result, even when all of the transmission timing information 133 transmitted from the base station device 1 is not received, the terminal device 2 in the present embodiment, for example, can specify the next transmission timing and can control the switching circuit 206. Therefore, in this case, the terminal device 2, for example, can reduce consumption of power for receiving the transmission timing information 133 transmitted from the base station device 1.

### Specific Example (3) of Transmission Timing Information

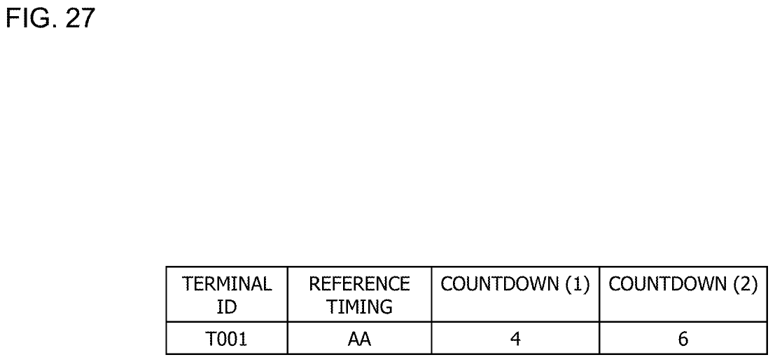

Next, a third specific example of the transmission timing information 133 is described. FIG. 27 is a view for describing a specific example of the transmission timing information 133.

The transmission timing information 133 illustrated in FIG. 27, for example, includes, as items thereof, “TERMINAL ID” in which information for identifying each terminal device 2 is set, and “REFERENCE TIMING” in which a timing at which the transmission timing information 133 is transmitted to each terminal device 2 is set. Further, the transmission timing information 133 illustrated in FIG. 27, for example, includes as an item thereof, “COUNTDOWN (1)” in which a time period from a timing set in “REFERENCE TIMING” to the next transmission timing of the timing set in “REFERENCE TIMING” is set. Moreover, the transmission timing information 133 illustrated in FIG. 27, for example, includes as an item thereof, “COUNTDOWN (2)” in which a time period from a timing set in “REFERENCE TIMING” to the second next transmission timing of the timing set in “REFERENCE TIMING” is set.

Specifically, in the transmission timing information 133 illustrated in FIG. 27, for example, “T001” is set as “TERMINAL ID”, “AA” is set as “TIMING”, “4 (FRAMES)” is set as “COUNTDOWN (1)”, and “6 (FRAMES)” is set as “COUNTDOWN (2)”.

That is, the transmission timing information 133 illustrated in FIG. 27, for example, indicates that, after the neighboring terminal device 2 corresponding to the terminal device 2 whose “TERMINAL ID” is “T001” transmits a signal to the base station device 1 at a timing that comes after four frames following “AA”, the neighboring terminal device 2 corresponding to the terminal device 2 whose “TERMINAL ID” is “T001” transmits a signal to the base station device 1 again at a timing that comes after six frames following “AA”.

In other words, the transmission timing information 133 illustrated in FIG. 27, for example, indicates that the terminal device 2 whose “TERMINAL ID” is “T001” can be charged (charged by wireless power feeding) at each of a timing that comes after four frames following “AA” and a timing that comes after six frames following “AA”.

### Specific Example (3) of Timing Reception Process

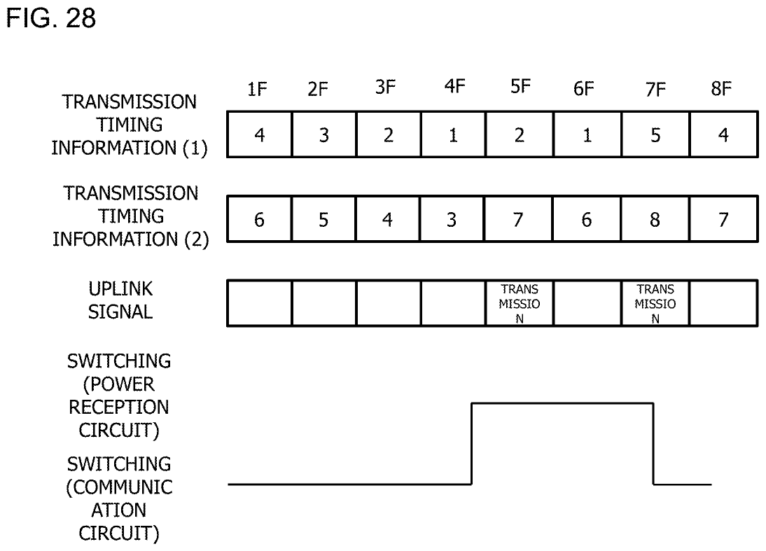

Next, a third specific example of the timing reception process is described. FIG. 28 is a view for describing a specific example of the timing reception process in the power-feeding control process in the first embodiment. Note that, in FIG. 28, “1F” to “8F”, “UPLINK SIGNAL”, “SWITCHING (POWER RECEPTION CIRCUIT)”, and “SWITCHING (COMMUNICATION CIRCUIT)” are similar to those in FIG. 23. Further, “TRANSMISSION TIMING INFORMATION (1)” and “TRANSMISSION TIMING INFORMATION (2)” are similar to “TRANSMISSION TIMING INFORMATION” in FIG. 23.

The example illustrated in FIG. 28, for example, indicates that, in each of the fourth frame and the sixth frame, the base station device 1 transmits the transmission timing information 133 in which “1” is set in “COUNTDOWN (1)”, to the neighboring terminal device 2, and in each of the fifth frame that is one frame after the fourth frame and the seventh frame that is one frame after the sixth frame (in other words, in each of frames in which “0” is set in “COUNTDOWN (1)”), the neighboring terminal device 2 transmits an uplink signal to the base station device 1.

In this respect, in the fourth frame in the example of FIG. 28, “1” is set in “COUNTDOWN (1)”, and “3” is set in “COUNTDOWN (2)”. That is, the example illustrated in FIG. 28, for example, indicates that a time period from the next transmission timing to the second next transmission timing is two frames. Thus, as illustrated in FIG. 28, for example, when it is determined that two frames that are a time period from the next transmission timing to the second next transmission timing are less than a predetermined threshold value (for example, three frames), the power-reception timing control unit 215 may be designed so as not to perform the second switching on the switching circuit 206 in the fifth frame that is the next transmission timing.

Meanwhile, in the sixth frame in the example of FIG. 28, “1” is set in “COUNTDOWN (1)”, and “6” is set in “COUNTDOWN (2)”. That is, the example illustrated in FIG. 28, for example, indicates that a time period from the second next transmission timing to the third next transmission timing is five frames. Thus, as illustrated in FIG. 28, for example, when it is determined that five frames that are a time period from the second next transmission timing to the third next transmission timing is equal to or greater than the predetermined threshold value, the power-reception timing control unit 215 may perform the second switching on the switching circuit 206 in the seventh frame that is the second next transmission timing.

As a result, the terminal device 2, for example, can reduce the number of times of the first switching and the second switching on the switching circuit 206. This enables the terminal device 2, for example, to reduce power consumption associated with control over the switching circuit 206.

Further, for example, even in a case where the terminal device 2 is incapable of receiving the transmission timing information 133 transmitted from the base station device 1 during the first switching on the switching circuit 206, the terminal device 2 can specify a timing (re-switching timing) at which the second switching is performed on the switching circuit 206.

According to one aspect, wireless power feeding to the terminal device can be efficiently performed.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A terminal device comprising:
a memory, and
processor circuitry coupled to the memory and the processor circuitry configured to:
receive a second signal including information on a predetermined timing at which a different terminal device transmits a first signal to a base station device, from the base station device; and
provide a first state in which first power is receivable, at the predetermined timing, in response to the second signal.

2. The terminal device according to claim 1, wherein
the second signal includes information indicating whether or not the predetermined timing comes after a predetermined time period following a timing at which the base station device transmits the second signal.

3. The terminal device according to claim 1, wherein
the second signal includes information indicating a time period from a timing at which the base station device transmits the second signal, to the predetermined timing.

4. The terminal device according to claim 1, further comprising
a power reception circuit configured to receive the first power when the first state is provided.

5. The terminal device according to claim 4, wherein
the power reception circuit receives power of the first signal transmitted to the base station device from the different terminal device, as the first power.

6. The terminal device according to claim 1, wherein
the processor circuitry provides the first state during a time period including the predetermined timing at least as a part thereof, in response to the second signal.

7. The terminal device according to claim 1, wherein
the processor circuitry provides a second state in which the first power is not received in at least a part of a time period other than the predetermined timing, in response to the second signal.

8. The terminal device according to claim 1, wherein
the processor circuitry transmits a third signal including information on a position of the terminal device, to the base station device.

9. The terminal device according to claim 1, wherein
the processor circuitry transmits a fourth signal including information indicating whether or not the terminal device requests reception of the first power, to the base station device.

10. A base station device that is wirelessly connected to a terminal device, the base station device comprising:
a memory, and
processor circuitry coupled to the memory and the processor circuitry configured to:
designate a different terminal device whose positional relationship with the terminal device satisfies a predetermined condition; and
transmit a second signal including information on a predetermined timing at which the different terminal device transmits a first signal to the base station device, to the terminal device.

11. The base station device according to claim 10, wherein
the processor circuitry receives a third signal including information on a position of the terminal device, from the terminal device, and
the processor circuitry designates the different terminal device on the basis of the information on the position of the terminal device.

12. The base station device according to claim 10, wherein
the processor circuitry designates a terminal device located at a distance equal to or less than a predetermined distance from the terminal device, as at least a part of the different terminal device.

13. The base station device according to claim 10, wherein
the processor circuitry receives a fourth signal including information indicating whether or not the terminal device requests reception of first power fed wirelessly, from the terminal device, and
the processor circuitry designates the different terminal device when the processor circuitry receives the fourth signal including the information indicating that the terminal device requests reception of the first power.

14. A wireless communication system comprising:
a terminal device; and
a base station device that is wirelessly connected to the terminal device, wherein the base station device includes:
a first memory, and
first processor circuitry coupled to the first memory and the first processor circuitry configured to:
designate a different terminal device whose positional relationship with the terminal device satisfies a predetermined condition, and
transmit a second signal including information on a predetermined timing at which the different terminal device transmits a first signal to the base station device, to the terminal device, and
the terminal device includes:
a second memory, and
second processor circuitry coupled to the second memory and the second processor circuitry configured to:
receive the second signal from the base station device, and
provide a first state in which first power is receivable, at the predetermined timing, in response to the second signal.
